(19) United States
(12) Patent Application Publication
(10) Pub. No.: US 2012/0162848 A1
(43) Pub. Date: Jun. 28, 2012

(54) IONIZER AND ELECTROSTATIC CHARGE ELIMINATING SYSTEM

(76) Inventors: Masahiko Ito, Sagamihara-City (JP); Yoshiaki Sato, Fujisawa-Shi (JP)

(21) Appl. No.: 13/321,289

(22) PCT Filed: May 26, 2010
(86) PCT No.: PCT/US10/36115

§ 371 Date: Nov. 18, 2011

(30) Foreign Application Priority Data
May 29, 2009 (JP) 2009-131105

(51) Int. Cl. H05F 3/06

(52) U.S. Cl. 361/213

(57) ABSTRACT

In an embodiment of the present invention, an ionizer and an electrostatic charge eliminating system are provided in which optional functions can be operated without increasing a current consumption when a timing of operating the optional functions is shifted in a case where a plurality of ionizers having optional functions such as a cleaning function are simultaneously used or an ionizer having a plurality of optional functions is used. According to an embodiment of the present invention, an ionizer includes: control portion 7; cleaning portion 10 operated when a command is given from control portion 7; first timer 5 for measuring a waiting time from a time at which a power source is turned on to a time at which cleaning portion 10 executes an operation at a first time; and second timer 6 for measuring a cycle time so that cleaning portion 10 can repeatedly execute the operation at a second time or later by a predetermined cycle time.

### TECHNICAL FIELD

The present invention relates to an ionizer and an electrostatic charge eliminating system for eliminating an electrostatic charge from an object by neutralizing the electrostatic charge when air ions are blown to the object which is electrically charged with static electricity and from which the electrostatic charge is to be eliminated.

### BACKGROUND

An example of the ionizer for eliminating an electrostatic charge from an object such as an IC chip or an electronic part having an insulating property is an air blasting type ion generating device described in Official gazette of JP-A-2004-234972. In the paragraph No. 0021 of Official gazette of JP-A-2004-234972, a means for generating air ions is described as follows. “Ion generating means 9 includes: annular opposed electrode 14 attached onto an outer circumference of air ion guide cylinder 12 made of insulating material connected to a front portion of shroud 11; and 8 discharge needles 15 radially arranged at regular intervals in a circumferential direction of the opposed electrode 14 in air ion guide cylinder 13. These discharge needles 15 are implanted in rod-shaped electrode holder 16 made of insulating material arranged in a central portion of air ion guide cylinder 13. Output cable 17a of high voltage AC power source 17 arranged in an inner bottom portion of case 4 is connected to discharge needles 15 through conductor 18 embedded in electrode holder 16. Return cable 17b of high voltage power source 17 is connected to opposed electrode 14. A corona discharge is generated between discharge needles 15 and opposed electrode 14 so as to generate positive and negative air ions.”

In the paragraphs Nos. 0022 to 0024, a cleaning means for removing dust from tips of the discharge needles is described as follows. “Cleaning means 10 includes: rod-shaped rotary member 20 rotated by a wind force having fin portion 19 with which an air current sent from air blasting means 8 collides; and brush member 21 attached to rotary member 20 through fin portion 19 (0022). A center in a longitudinal direction of rotary member 20 is supported by supporting portion 22 arranged in the front of electrode holder 16. Rotary member 20 can be freely rotated about a concentric axis with an annular center of opposed electrode 14 (0023). Brush member 21 is made of plastics such as nylon resin or acrylic resin. Brush member 21 is attached at a position in a radial direction corresponding to a distance from an annular center of opposed electrode 14 to a tip of each discharge needle 15 through brush attaching member 23. When rotary member 20 is rotated, brush member 21 comes into contact with the tips of discharge needles 15 (0024).”

### SUMMARY OF THE INVENTION

In general, an operation current to operate an ionizer having an electric fan is approximately 1 A. However, when a cleaning function for cleaning a discharge electrode (a discharge needle) is added, a current to drive a brush for cleaning is added to the operation current of the ionizer. Therefore, a total current is multiplied by several times. In a case where a plurality of ionizers are used for a manufacturing line, in which electronic parts are manufactured, such as a semiconductor manufacturing line, electric power sources of the plurality of ionizers are totally turned on and off by a main power source switch. Accordingly, a total electric current consumption for simultaneously operating all the ionizers is further increased. For example, when a plurality of ionizers are used for an IC handler (a semiconductor chip conveying device), it is necessary to sufficiently increase a current capacity of the IC handler so that the operation of the device can not be affected even when all the ionizers consume the respective maximum current consumption.

In an embodiment of the present invention, an ionizer and an electrostatic charge eliminating system are provided in which optional functions can be operated without increasing a current consumption when timing of operating the optional functions is shifted in the case where a plurality of ionizers having optional functions such as a cleaning function are simultaneously used or an ionizer having a plurality of optional functions is used.

In one embodiment, the present invention provides an ionizer for eliminating an electrostatic charge from an object by neutralizing the electrostatic charge when air ions are blown to the object which is electrically charged with static electricity and from which the electrostatic charge is to be eliminated, comprising: a control portion; a functional portion operated when a command is given from the control portion to it; a first timer for measuring a waiting time from a time at which an electric power source is turned on to a time at which the functional portion executes an operation at a first time; and a second timer for measuring a cycle time so that the functional portion can repeatedly execute the operation at a second time or later by a predetermined cycle time.

In another embodiment, the present invention provides an electrostatic charge eliminating system having a plurality of ionizers for eliminating an electrostatic charge from an object by neutralizing the electrostatic charge when air ions are blown to the object which is electrically charged with static electricity and from which the electrostatic charge is to be eliminated, wherein the plurality of ionizers are supplied with electric power from a common electric power source, each ionizer including: a control portion; a functional portion operated when a command is given from the control portion to it; a first timer for measuring a waiting time from a time at which an electric power source is turned on to a time at which the functional portion executes an operation a first time; and a second timer for measuring a cycle time so that the functional portion can repeatedly execute the operation at a second time or later by a predetermined cycle time, wherein each ionizer operates the functional portion while the timing of operating the functional portion is being shifted.

According to the ionizer and the electrostatic charge eliminating system of the present invention, when the timing of operating the optional function is shifted, it is possible to operate the optional function without increasing the current consumption. Due to the foregoing, it is possible to simultaneously use a plurality of ionizers having an optional function such as a cleaning function. Further, it is possible to use an electrostatic charge eliminating device having a plurality of optional functions.

### BRIEF DESCRIPTION OF THE DRAWINGS

FIG. 1 is a block diagram of an ionizer (an electrostatic charge eliminating device) and an electrostatic charge eliminating system of the first embodiment of the present invention.

FIG. 2 is a detailed block diagram of the ionizer shown in FIG. 1.

FIG. 3 is a flow chart showing a cleaning operation of each ionizer shown in FIG. 2.

FIG. 4 is a time chart at the time of a cleaning operation executed by each ionizer.

FIG. 5 is a time chart at the time of a cleaning operation executed by a plurality of ionizers at the same timing.

FIG. 6 is a time chart at the time of a cleaning operation executed by a plurality of ionizers when the timing is shifted.

FIG. 7 is a block diagram of an ionizer and an electrostatic charge eliminating system of the second embodiment of the present invention.

FIG. 8 is a block diagram of each ionizer of the electrostatic charge eliminating system shown in FIG. 7.

FIG. 9 is a circuit diagram of a plurality of ionizers of the electrostatic charge eliminating system shown in FIG. 7.

FIG. 10 is a flow chart at the time of a cleaning operation executed by each ionizer shown in FIG. 7.

FIG. 11 is a time chart at the time of a cleaning operation executed by a plurality of ionizers shown in FIG. 7 when the third timer is used while the timing is being shifted.

FIG. 12 is a time chart at the time of a cleaning operation executed by a plurality of ionizers shown in FIG. 7 when the third timer is not used while the timing is being shifted.

FIG. 13 is a block diagram of the ionizer of the third embodiment of the present invention.

FIG. 14 is a detailed block diagram of the control unit of the ionizer shown in FIG. 13.

FIG. 15 is a detailed block diagram of the electrostatic charge eliminating unit of the ionizer shown in FIG. 13.

FIG. 16 is a flow chart at the time of a cleaning operation executed by the ionizer shown in FIG. 13.

FIG. 17 is a block diagram of the ionizer of the fourth embodiment of the present invention.

### DETAILED DESCRIPTION

According to an embodiment of the present invention, an ionizer (an electrostatic charge eliminating device) includes: a control portion; at least one functional portion operated when a command is given from the control portion to the functional portion; a first timer for measuring a waiting time from a time at which a power source is turned on to a time at which the functional portion executes an operation at a first time; and a second timer for measuring a cycle time so that the functional portion can repeatedly execute the operation at a second time or later by a predetermined cycle time. According to an embodiment of the present invention, an electrostatic charge eliminating system includes a plurality of ionizers that receive electric power from a common electric power source. A functional portion of each ionizer has optional functions such as a cleaning function and an air blasting function operated when electric power is supplied from an electric power source.

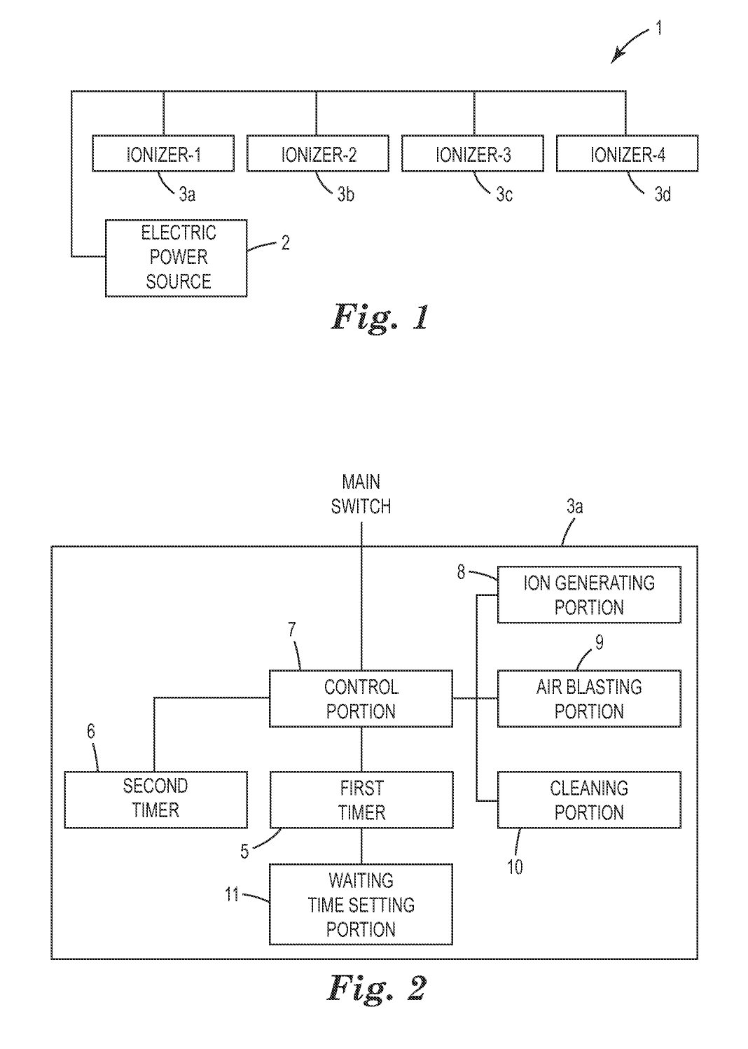

Referring to the drawings, an embodiment of the ionizer and the electrostatic charge eliminating system of the present invention will be explained below. FIG. 1 shows an ionizer and an electrostatic charge eliminating system of the first embodiment of the present invention. As shown in the drawing, although electrostatic charge eliminating system 1 of the present embodiment is not restricted by this embodiment, for example, electrostatic charge eliminating system 1 of the present embodiment can be applied to an IC handler of a semiconductor manufacturing system in a clean room. Electrostatic charge eliminating system 1 includes a plurality of ionizers 3a to 3d. Ionizers 3a-3d are connected to electric power source 2 (for example, DC electric power source) in parallel. Further, electric power source 2 is electrically connected to an IC handler and various devices so that electric power can be supplied. An allowable current of electric power source 2 is decided at a predetermined ampere. Therefore, in a case where an electric current, the intensity of which exceeds the allowable current, is consumed, a breaker is operated. It is typical that ionizers 3a to 3d of the electrostatic charge eliminating system are connected to the electric power source of the IC handler and others. However, ionizers 3a to 3d of the electrostatic charge eliminating system may be connected to an electric power source provided differently.

The number of ionizers 3a-3d is not limited to four but it is possible to use ionizers, the number of which is two or more. However, the number of the ionizers to be used is restricted by the allowable current of electric power source 2. Ionizers 3a to 3d used for the present embodiment have a cleaning function as an optional function. Each ionizer used for the present embodiment has second timer 6 for measuring a cycle time, at which a discharge electrode to generate corona discharge together with an opposed electrode (not shown) is cleaned, as a timer for measuring the cycle time to periodically execute a cleaning function. Four ionizers 3a to 3d are electrically connected to a main switch of IC handler not shown. Therefore, the electric power source can be simultaneously turned on and off by the main switch.

In general, the ionizer includes: a discharge electrode arranged being opposed to the opposed electrode; an ion generating portion for generating corona discharge between the opposed electrode and the discharge electrode; and an air blasting portion (a blower) for blowing the generated ions to an object from which an electrostatic charge is to be eliminated. In the ionizer, when ionized air is blown to the object from which an electric charge is to be eliminated, the electrostatic charge can be eliminated from the object.

An arrangement of the discharge electrodes can be arbitrarily determined. It is typical that the discharge electrodes are radially arranged in a direction perpendicular to the air flowing direction. The number of the electrodes is determined according to an electrostatic capacity and is not particularly restricted. However, for example, the electrode, the number of which is four, can be arranged at regular intervals. The discharge electrode is made of, for example, tungsten alloy. Concerning its dimensions, for example, the diameter is 1.5 mm and the length is 20 mm. Voltage applied to the discharge electrode is approximately +, −5000v in a case of a DC type ionizer.

The air blasting portion is a device for generating a wind force capable of blowing a blast of ionized air to an object from which an electrostatic charge is to be eliminated. The air blasting portion may be of the structure in which a fan is rotated by a motor. Alternatively, the air blasting portion may be of the structure in which a tube of compressed air is connected to the ionizer and a blast of air is sent by the pressure of compressed air.

As shown in FIG. 2, the ionizer of the present embodiment includes: conventional ion generating portion 8; and air blasting portion 9. Further, the ionizer of the present embodiment includes: cleaning portion (an optional function) 10 for periodically cleaning a tip portion of the discharge electrode so as to remove dirt attached to the tip portion of the discharge electrode; first timer 5 for measuring waiting time t₁ from a time at which an electric power source is turned on to a time at which cleaning portion 10 executes an operation at the first time; waiting time setting portion 11 for setting a waiting time at first timer 5; second timer 6 for measuring cycle time t₂ so that cleaning portion 10 can be made to repeatedly execute the operation at the second time or later by the predetermined cycle time; and control portion 7 for giving a command to operate cleaning portion 10. Cleaning portion 10 includes: a movable portion (not shown) operated by a power source such as a solenoid or a motor; and a brush (not shown) for removing dirt from the tip of the discharge electrode when the brush is moved together with the movable portion. Cleaning is carried out in such a manner that the brush is reciprocated with being contacted with the tip of the discharge electrode, for example, for several seconds to several tens seconds. When the discharge electrode is cleaned, the ionizer consumes an electric current, the intensity of which is several times as much as the electric current consumed at the time of generating ions. The waiting time, from a time at which the electric power source 2 is turned on to a time at which the operation of the cleaning portion 10 is started, is set at first timer 5. A random circuit for automatically generating random numbers can be applied to waiting time setting portion 11. However, it is possible to set the waiting time in such a manner that an operator manually turns a dial provided in the timer. In the same manner, waiting time setting portion 11 can set cycle time t₂ at second timer 6. In this connection, individual ionizers 3a to 3d are not restricted by the form of the present embodiment but it is possible to provide an optional function such as a wind direction changing means for changing an air blasting direction.

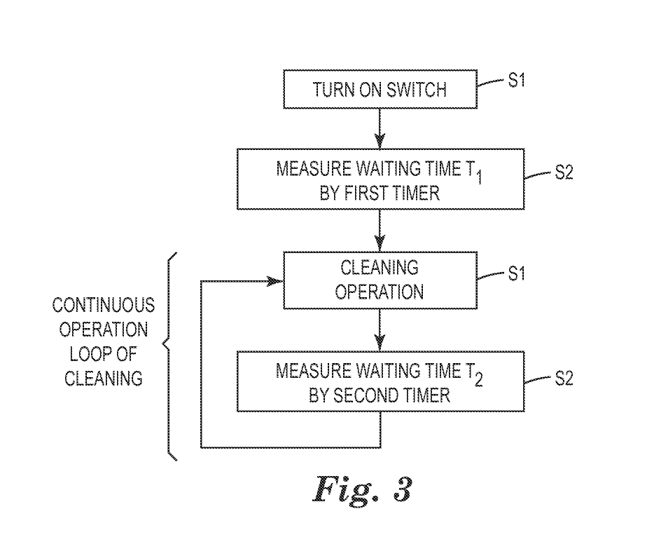

FIG. 3 is a flow chart of cleaning individual ionizers 3a to 3d. When the electric power source of the ionizer is turned on in step S1, the discharge electrode starts discharging and the ionizer starts blowing a blast of ionized air. At the same time, first timer 5 measures predetermined waiting time t₁ (step S2). After waiting time t₁ has passed, cleaning portion 10 starts an operation and the discharge electrode is cleaned (step S3). Simultaneously when step S3 is started, second timer 6 starts measuring the time. After predetermined cycle time t₂ has passed (step S4), cleaning portion 10 starts the operation again and cleans the discharge electrode. After that, predetermined cycle time t₂ has passed, the discharge electrode is repeatedly cleaned. In this connection, cycle time t₂ may be constant. Alternatively, cycle time t₂ may be changed by a predetermined pattern or at random so that the cleaning interval can be changed.

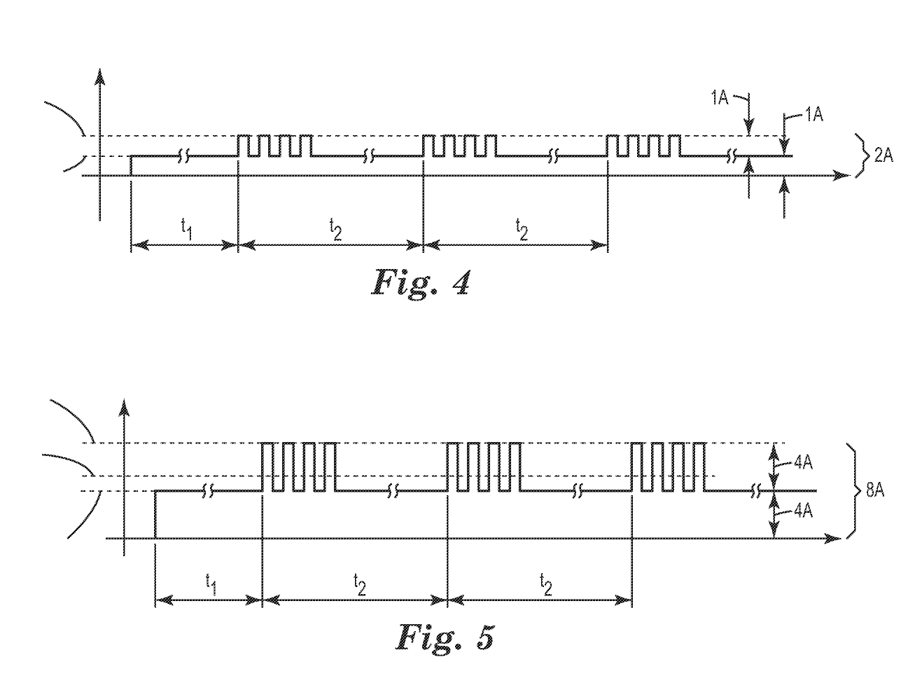

FIG. 4 is a time chart at the time of a cleaning operation carried out by one set of ionizer 3a to 3d. First timer 5 measures waiting time t₁ from a time at which electric power source 2 is turned on to a time at which a cleaning operation is started. When waiting time t₁ has passed, second timer 6 starts measuring cycle time t₂ that is arbitrarily decided and cleaning is executed again. In the present embodiment, cycle time t₂ can be set, for example, at one hour. In each ionizer 3a to 3d of the present embodiment, the current consumption at the time of generating ions is 1 A and the current consumption at the time of cleaning is 2 A.

FIG. 5 is a time chart at the time of a cleaning operation carried out by four sets of ionizers 3a to 3d at the same timing. FIG. 5 shows a comparative example. As shown in the time chart, when four sets of ionizers 3a to 3d are simultaneously operated, the current consumption at the time of generating ions is 4 A. Therefore, the total current consumption at the time of the cleaning operation is 8 A. In order to operate each ionizer 3a to 3d at this timing, it is necessary to use electric power source 2, the allowable current is not less than 8 A.

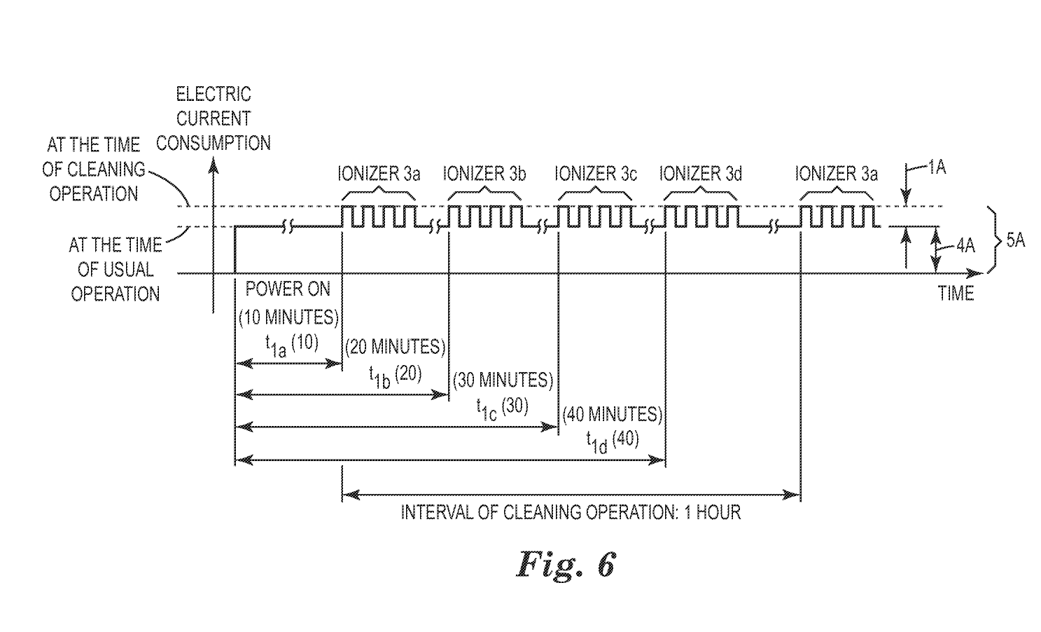

FIG. 6 is a time chart at the time of a cleaning operation in which ionizers 3a-3d are operated at the shifted timing. As shown in the time chart, waiting time t₁ₐ to t_{1d} of first timer 5 is set to be longer by 10 minutes from 10 minutes to 40 minutes so that the respective cleaning start timing can be shifted at an interval of 10 minutes. Therefore, the cleaning operation of the discharge electrode is not simultaneously executed. Accordingly, the total current consumption at the time of the cleaning operation can be suppressed at 5 A.

As described above, according to ionizers 3a to 3d and electrostatic charge eliminating system 1 of the present embodiment, the timing at which first timer 5 is operated is shifted with respect to individual ionizers 3a to 3d. Accordingly, the current consumption can be prevented from increasing.

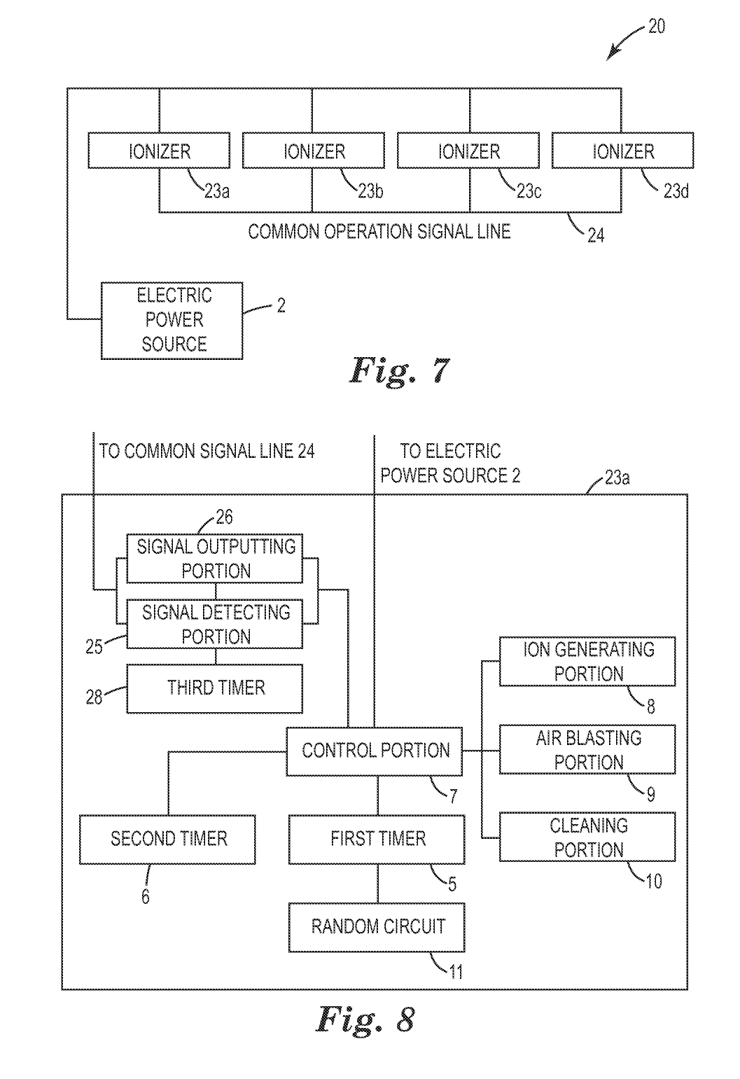

Next, the ionizer and the electrostatic charge eliminating system of second embodiment will be explained below. As shown in FIG. 7, the electrostatic charge eliminating system of the present embodiment includes: electric power source 2; and ionizers 23a to 23d. As shown in FIG. 8, each ionizer 23a to 23d includes: second timer 6; first timer 5 for setting waiting time t₁ by random circuit 11; and third timer 28 for measuring waiting time t₃ to a time at which a voltage level of common signal line 24 is detected when other ionizer 23a to 23d is executing the cleaning operation. Each ionizer 23a to 23d of the present embodiment includes: signal detecting portion 25 connected to common signal operation line 24 and detecting a voltage level of common operation signal line 24; and signal output portion 26 for outputting an operation signal to common operation signal line 24 so that a voltage level of common operation signal line 24 can be decreased.

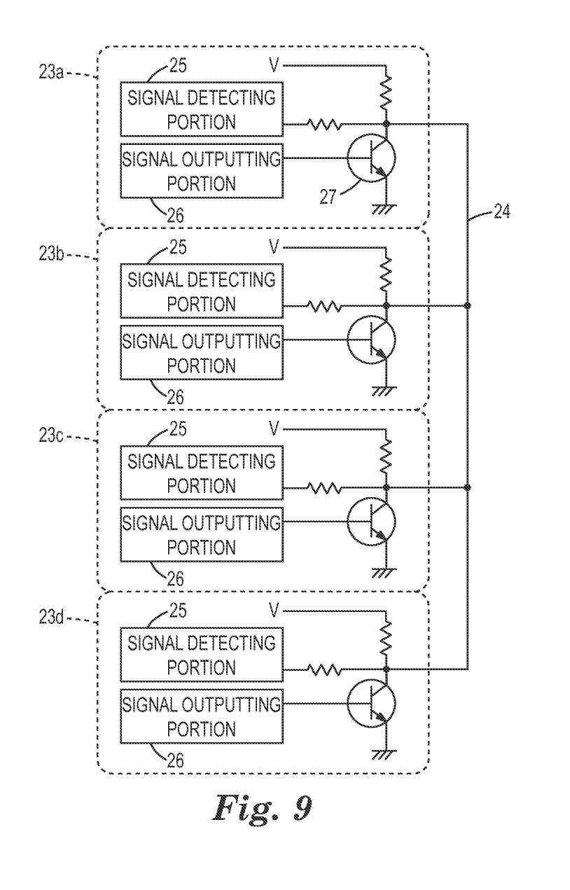

FIG. 9 is a circuit diagram of a plurality of ionizers 23a to 23d connected to common signal operation line 24. Signal detecting portion 25 of each ionizer 23a to 23d detects whether the voltage level of common operation signal line 24 is in high or low. At the same time, signal detecting portion 25 of each ionizer 23a to 23d judges that other ionizer 23a to 23d is executing the cleaning operation when the detected voltage level is low. Signal detecting portion 25 of each ionizer 23a to 23d judges that no ionizers 23a-23d are not executing the cleaning operation when the detected voltage level is high. When each ionizer 23a to 23d is executing the cleaning operation, signal output portion 26 outputs an operation signal, which is a minute electric current, to common operation signal line 24 through transistor 27. Transistor 27 is of the type NPN. When an operation signal (an electric current) is sent from signal output portion 26 to the base, a resistance value between the emitter and the collector is greatly lowered and the voltage level of common operation signal line 24 becomes low. When each ionizer 23a to 23d is not executing the cleaning operation, signal output portion 26 does not output an operation signal. As a result, the collector and the emitter are set in an open state from each other. Accordingly, the voltage of DC power source V is applied to the common operation signal line as it is. Therefore, the voltage level becomes high.

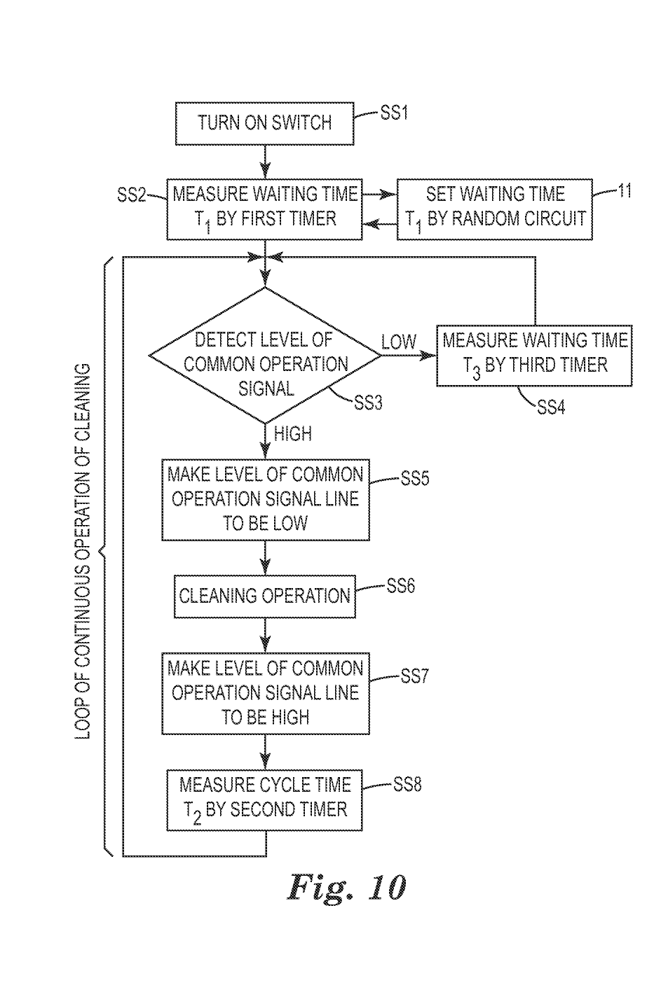

FIG. 10 is a flow chart at the time of a cleaning operation of each ionizer 23a to 23d. First timer 5 measures waiting time t₁ from a time at which the electric power source of ionizer 23a to 23d is turned on to a time at which the first time cleaning operation is started. Second timer 6 measures cycle time t₂ of a predetermined cleaning interval. The third timer measures waiting time t₃ at which the start of the cleaning operation is delayed when other ionizer 23a to 23d is executing the cleaning operation. That is, in a case where the timing of cleaning is overlapped with that of other ionizer 23a to 23d, the waiting time for starting the cleaning operation is prolonged so as to shift the timing.

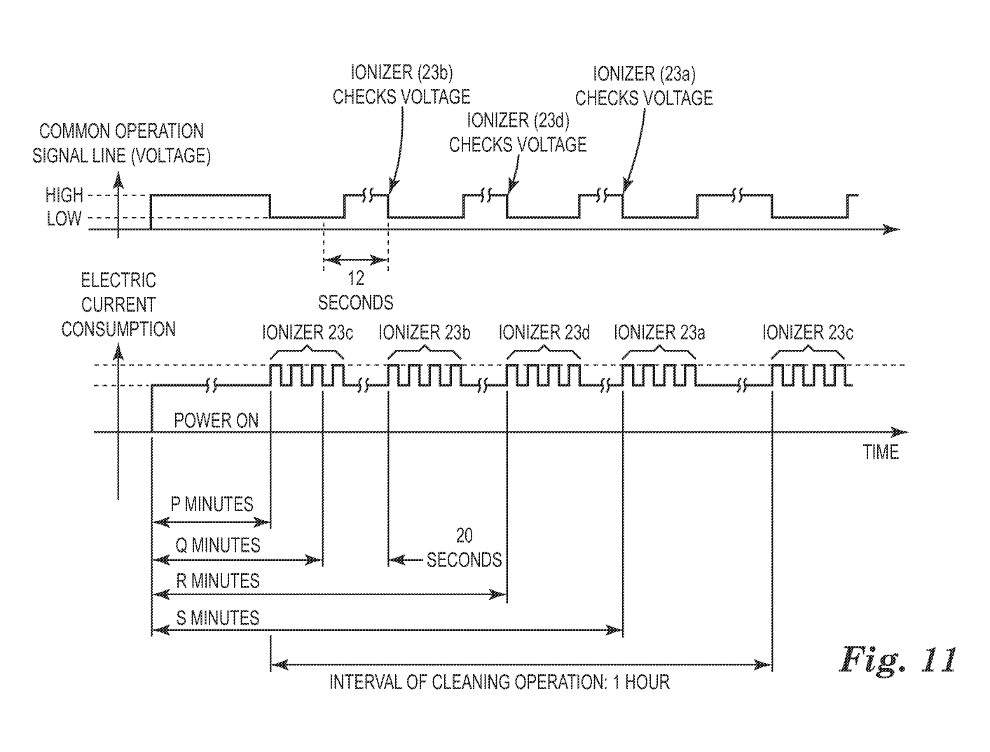

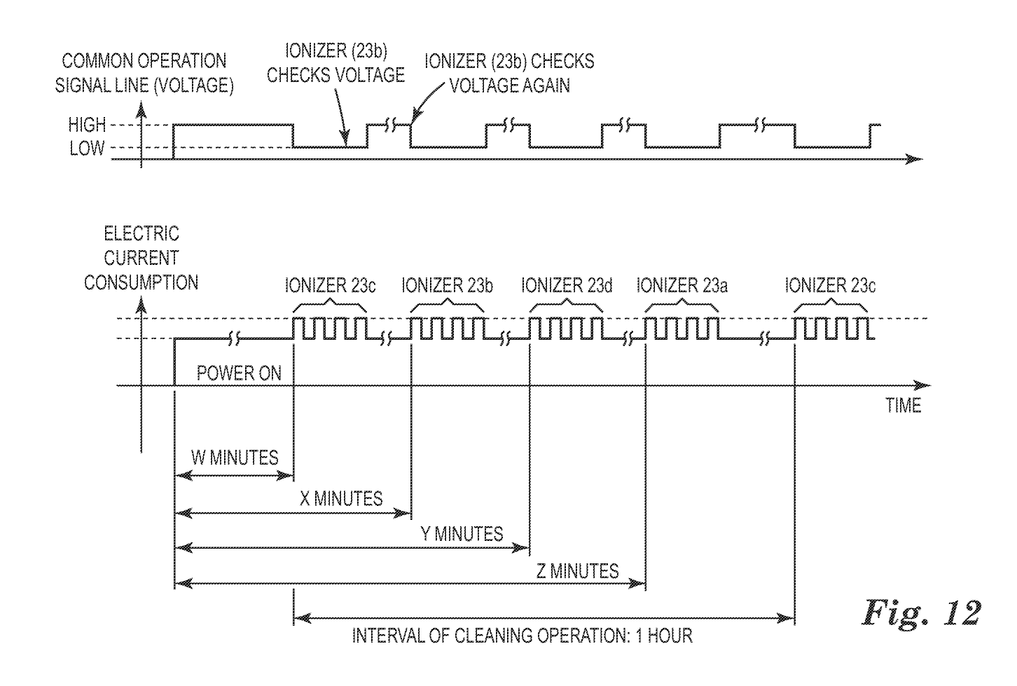

Specifically, for example, in a case where cycle time t₂ of cleaning is set at one hour, it is set so that waiting time t₁ of first timer 5 can be set at random in range from 0 second to 50 minutes (subtracted 10 minutes from the cycle time) by random circuit 11 in step SS2. After this time has passed, when the voltage given to common operation signal line 24 is detected in step SS3, it is checked whether or not other ionizer 23a to 23d is executing the cleaning operation by using common electric power source 2. In a case where other ionizer 23a to 23d is executing the cleaning operation (Refer to FIG. 11.), the program proceeds to step SS4 and the cleaning operation time is set at 10 seconds. Then, waiting time t₃ of the third timer is set at the time longer than 10 seconds, for example, waiting time t₃ of the third timer is set at 20 seconds and it is checked again whether or not other ionizer 23a to 23d is executing the cleaning operation by using common operation signal line 24. In a case where no ionizer 23a to 23d is executing the cleaning operation (Refer to FIG. 12.), the program proceeds to step SS5 and signal output portion 26 outputs an operation signal and makes a voltage level of common operation signal line 24 to be low. Due to the foregoing, the ionizer is made to be unable to execute the cleaning operation at the same timing as that of other ionizer 23a to 23d. When the cleaning operation is finished in step SS6, the voltage level of common operation signal line 24 is returned to high in step SS7. After the program has waited for predetermined cycle time t₂ (step SS8) from step SS6, the program returns to step SS3 and the cleaning operation is repeatedly executed. In this connection, it is possible that the program is not returned to SS3 but returned to SS6 at the second time and after that and the cleaning operation is repeatedly executed. Waiting time t₃ of the third timer can be also set by the random circuit.

In the embodiment described above, even when waiting time t₁ of first timer 5 is not previously set so that a plurality of ionizers 23a to 23d can not be overlapped with each other, it is possible to prevent the plurality of ionizers 23a to 23d from executing the cleaning operation at the same timing.

A variation of the present embodiment is described as follows. In the ionizer, instead of watching the voltage of common operation signal line 24 by using the third timer at predetermined intervals, the voltage of common operation signal line 24 may be detected at all times. In this variation, when the common operation signal level is low in step SS3 in FIG. 10, the ionizer continuously detects the common operation signal level. Then, when it is detected that the common operation signal level is high, the program can be transferred to step SS5. In other words, waiting time t₃ of step SS4 may be substantially 0 second. In this case, the ionizer may not be provided with the third timer.

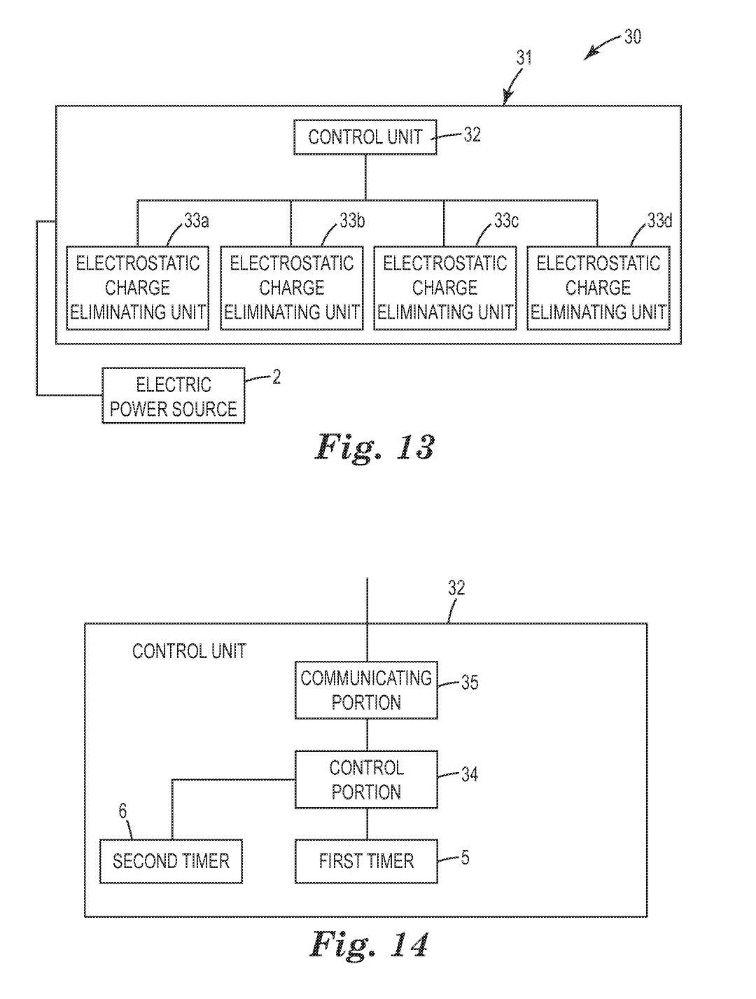

Next, the ionizer and the electrostatic charge eliminating system of the third embodiment of the present invention will be explained below. As shown in FIG. 13, the electrostatic charge eliminating system of the present embodiment includes: electric power source 2; and ionizer 31. Ionizer 31 includes: control unit 32; and a plurality of electrostatic charge eliminating units 33a to 33d connected to control unit 32. Each electrostatic charge eliminating unit 33a to 33d is connected to common electric power source 2. As shown in FIG. 14, control unit 32 includes: control portion 34; first timer 5; second timer 6; and communicating portion 36 for sending and receiving signals from communicating portions 36 of electrostatic charge eliminating units 33a to 33d.

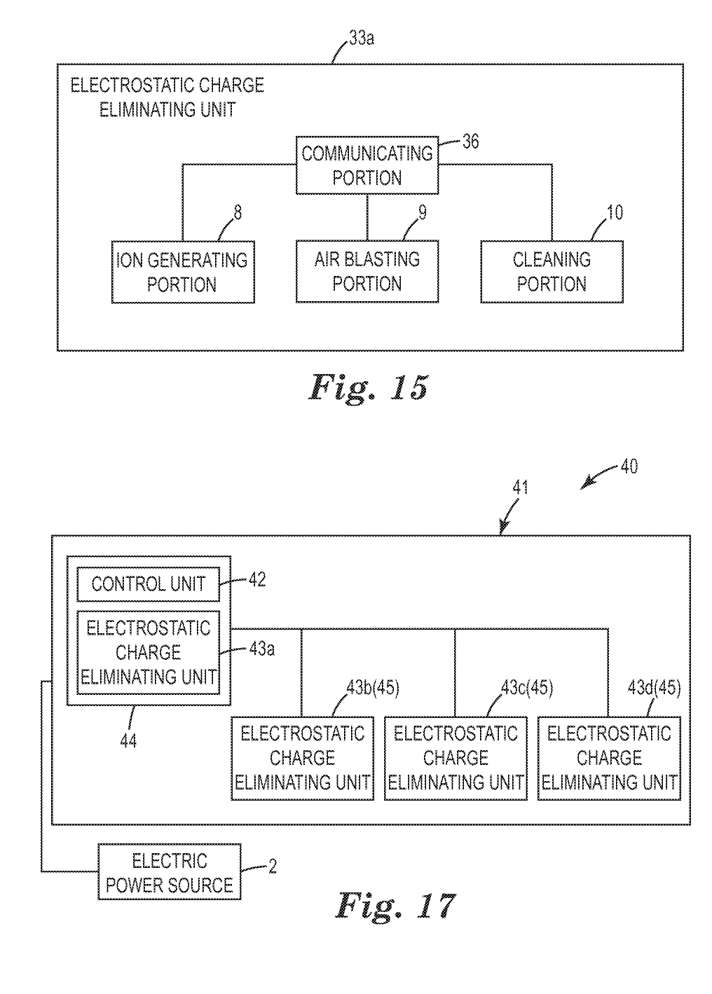

As shown in FIG. 15 in which electrostatic charge eliminating unit 33a is shown as a representation, each electrostatic charge eliminating unit 33a to 33d includes: ion generating portion 8; air blasting portion 9; cleaning portion 10; and communicating portion 36 for sending and receiving signals from communicating portion 35 of control unit 32. Communicating portion 36 sends a result of detecting the operation of cleaning portion 10 to control unit 32 and receives a command for starting the cleaning operation from control unit 32. Control unit 32 gives a command of starting the cleaning operation to each electrostatic charge eliminating unit 33a to 33d according to delay time t₁ and cycle time t₂ measured by first timer 5 and second timer 6. The same communicating portion as communicating portion 35 of control unit 32 can be used for communicating portion 36.

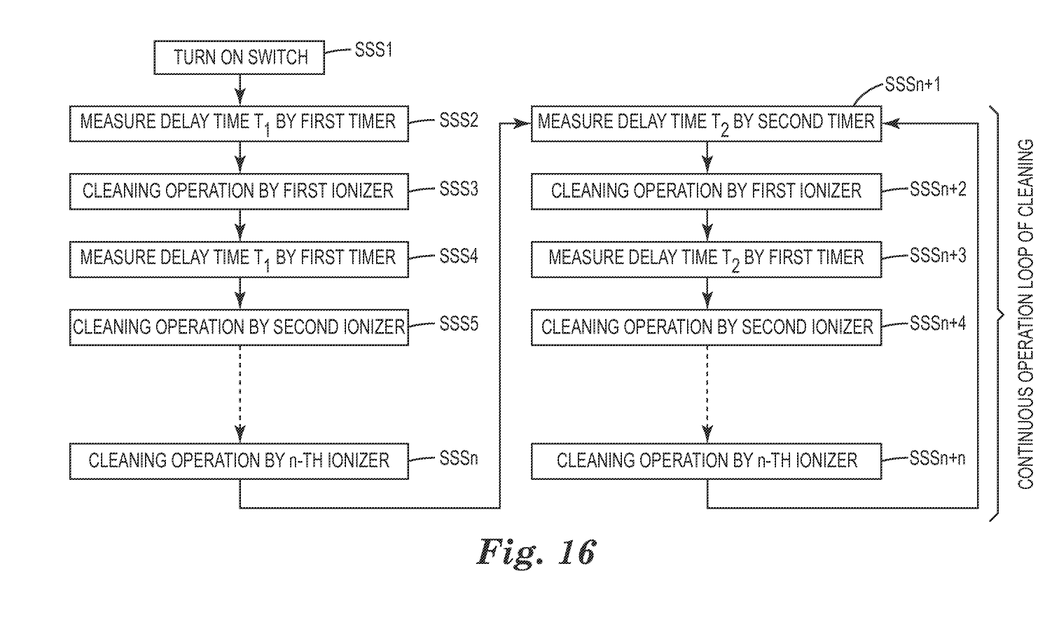

FIG. 16 is a flow chart for explaining an operation of the electrostatic charge eliminating system of the present embodiment. When a switch of ionizer 31 has been turned on (step SSS1) and predetermined waiting time t₁ has passed (step SSS2), control unit 32 sends a command of starting the cleaning operation to first electrostatic charge eliminating unit 33a. When first electrostatic charge eliminating unit 33a receives the command from control unit 32, the cleaning operation of cleaning the discharge electrode is started (step SSS3). After predetermined waiting time t₁ has passed from the start of the cleaning operation by first electrostatic charge eliminating unit 33a (SSS4), control unit 32 sends a command of starting the cleaning operation to second electrostatic charge eliminating unit 33b. Second electrostatic charge eliminating unit 33b receives the command sent from control unit 32 and starts the cleaning operation of cleaning the discharge electrode (SSS5). Other electrostatic charge eliminating units 33c, 33d connected to control unit 32 are also cleaned in the same manner (SSSn). As described above, electrostatic charge eliminating units 33a to 33d execute the cleaning operation of cleaning the discharge electrodes in order after waiting time t₁ has passed.

After all electrostatic charge eliminating units 33a to 33d have finished the cleaning operation, when predetermined cycle time t₂ has passed from the start of first electrostatic charge eliminating unit 33a (SSSn+1), control unit 32 sends a command of starting the second time cleaning operation of cleaning the discharge electrode to first electrostatic charge eliminating unit 33a. First electrostatic charge eliminating unit 33a receives the command from control unit 32 and starts the second time cleaning operation of cleaning the discharge electrode (SSSn+2). In the same manner, the second time cleaning operation is executed for other electrostatic charge eliminating unit 33b to 33d (SSSn+2 to SSSn+n). After cycle time t₂ has passed, each electrostatic charge eliminating unit 33a to 33d repeatedly executes the operation in order so as to clean the discharge electrodes.

In this connection, an interval between the cleaning operation of first electrostatic charge eliminating unit 33a and that of second electrostatic charge eliminating unit 33b may be constant or variable when waiting time t₁ is changed at random. Alternatively, the following constitution may be employed. As shown in FIG. 17, a plurality of slave units 45, which are electrostatic charge eliminating units 43b to 43d, are connected to master unit 44 having control unit 41 and electrostatic charge eliminating unit 43a in the same housing, so that the system can be composed. In this case, it is unnecessary to provide a communicating portion for connecting control unit 41, which is in the same housing (the master unit 44), to electrostatic charge eliminating unit 43a. Control unit 41 and electrostatic charge eliminating unit 43a may be communicated with each other through an electric power source line. Alternatively, control unit 41 and electrostatic charge eliminating unit 43a may be communicated with each other through a communicating line arranged differently from the electric power source line.

In this specification, the ionizer and the electrostatic charge eliminating system are explained above. However, it should be noted that the present invention is not restricted by the embodiment disclosed above and variations and improvements of the present invention may be made. In this specification, explanations are made into ionizers 3a to 3d and 23a to 23d having the cleaning portions for cleaning the discharge electrodes. However, instead of the cleaning portion, a wind direction changing function of changing a wind direction can be made to be a functional portion, that is, it should be noted that a form of the functional portion is not restricted by a specific embodiment. Further, the ionizer may be provided with a rectifier or a transformer and the electric power sent from electric power source 2 may be converted and consumed.

1. An ionizer for eliminating an electrostatic charge from an object by neutralizing said electrostatic charge when air ions are blown to said object which is electrically charged with static electricity and from which said electrostatic charge is to be eliminated, said ionizer comprising:
a control portion;
a functional portion operated when a command is given from said control portion thereto;
a first timer for measuring a waiting time from a time at which an electric power source is turned on to a time at which said functional portion executes an operation at a first time; and
a second timer for measuring a cycle time so that said functional portion can repeatedly execute said operation at a second time or later by a predetermined cycle time.

2. The ionizer according to claim 1, wherein said functional portion is a cleaning portion for cleaning a discharge electrode which generates a corona discharge with an opposed electrode.

3. The ionizer according to claim 1, wherein said first timer includes a random circuit for setting said waiting time at said first timer.

4. The ionizer according to claim 1, further comprising:
a control unit having said control portion, said first timer and said second timer; and
a plurality of electrostatic charge eliminating units respectively having said functional portions,
wherein said control portion makes said first timer measure said waiting time and also makes said second timer measure said cycle time, and controls the plurality of electrostatic charge eliminating unit so that said functional portions of said electrostatic charge eliminating units can be operated in order.

5. The ionizer according to claim 1, further comprising:
a signal detecting portion for detecting a voltage level of a common operation signal line electrically connected to a plurality of ionizers; and
a signal outputting portion for outputting an operation signal to said common operation signal line so as to decrease a voltage level of said common operation signal line to a value lower than a predetermined voltage level when said functional portion is operated,
wherein said control portion judges a timing to operate said functional portion according to said voltage level detected by said signal detecting portion.

6. An electrostatic charge eliminating system having a plurality of ionizers for eliminating an electrostatic charge from an object by neutralizing said electrostatic charge when air ions are blown to said object which is electrically charged with static electricity and from which said electrostatic charge is to be eliminated, wherein the plurality of ionizers are supplied with electric power from a common electric power source, each ionizer including:
a control portion;
a functional portion operated when a command is given from the control portion thereto;
a first timer for measuring a waiting time from a time at which an electric power source is turned on to a time at which said functional portion executes an operation at a first time; and
a second timer for measuring a cycle time so that said functional portion can repeatedly execute said operation at a second time or later by a predetermined cycle time, wherein
each ionizer operates said functional portion while a timing of operating said functional portion is being shifted.
